(19) United States
(12) Patent Application Publication
(10) Pub. No.: US 2003/0073366 A1
(43) Pub. Date: Apr. 17, 2003

(54) Flat low friction cord

(76) Inventor: Adrian Benetti, Footscray (AU)

Correspondence Address: LARSON & TAYLOR, PLC, 1199 NORTH FAIRFAX STREET, SUITE 900, ALEXANDRIA, VA, 22314, US

(21) Appl. No.: 09/986,774

(22) Filed: Nov. 9, 2001

(30) Foreign Application Priority Data
Nov. 13, 2000 (AU) PR1439

(51) Int. Cl. D04B 1/00; D04B 7/00; D04B 9/00; D04B 11/00; D04B 21/00; B32B 19/00; D04H 1/00; D04H 3/00; D04H 5/00; D04H 13/00; B32B 5/16

(52) U.S. Cl. 442/365; 428/357; 442/364

(57) ABSTRACT

A flat low friction cord and a method of production of a cord comprising a flexible and substantially flat core enshrouded by a knitted cover, the cover being knitted around the core from yarns, wherein the knitted yarns at the cord surface define a low friction and abrasion resistant sliding surface. The yarns may be oriented substantially along the cord. The yarns may be twisted in one direction. The knitted cover may sufficiently cover the flat core such that the core cannot be seen through the cover. The denier of the yarns is preferably 1500 denier and the yarn fibers are preferably a polyester, nylon, polypropylene or the like, with polyester and nylon the preferable yarn fibers. The core may be a foamed PVC, polyester, polyethylene, polypropylene or the like but is preferably extruded foamed PVC. The core may be heat set to firmly enshroud the cover around the core.

### INTRODUCTION

The present invention relates to a method and apparatus for producing a flat low friction cord suitable for use with automated roller doors. The present invention relates also to the flat low friction cord itself.

### BACKGROUND OF THE INVENTION

Automated roller doors are used in domestic and industrial garages, warehouses, commercial sites, storage facilities, and the like. Generally, roller doors are provided with some kind of low friction dampening means between the sliding metal roller door and metal guide rails so as to prevent contact of metal on metal which can lead to door damage and unacceptable levels of noise and vibration. The dampening means is typically a strip or cord stapled at the sides of the door and moves with the door in the guide rails thereby deadening the sound and vibration caused by the roller door moving in the guide rails. The result is a smoother sliding roller door.

Noise and vibration dampening cords for roller doors commonly comprise synthetic fibres plaited over a flat synthetic absorbing core to form a cover or sheath over the core. The core is usually extruded foamed PVC, polyester, polyethylene and polypropylene, whilst the fibres are usually polyester, nylon or polypropylene yarns. A plaiting machine comprising a disc-carrier with a large central opening is used to plait the yarns onto the extruded core. Bobbins are arranged on the carrier around the opening, and an extruded core is fed centrally upwards through the opening. Yarns from the bobbins are plaited around the core by way of bobbins rotating in an opposite direction to an equal number of adjacent bobbins. The plaited cover is continuously plaited around the core as the core moves upwardly through the carrier and then taken up on a reel.

Plaiting yarns around a flat core yields a yarn pattern with yarn fibres oriented approximately 45°-90° to the longitudinal direction of the cord. This type of construction where the fibres lie in a direction that is more transverse to the cord than along the cord increases abrasion of the fibres as the roller door moves along the guides. Although presence of a cord reduces noise and vibration, the friction created between the cord and metallic guide rails still creates a noticeably rough sliding motion and vibration. Furthermore, the plaited cover contains crossed fibres that stand proud of the surface of the cover giving a textured surface which further increases the frictional properties of the cord. Despite these disadvantages, plaited fibre covers are strong under tension and able to firmly hug a flat core with minimal movement. Figure A illustrates a known plaited roller door cord.

To overcome problems with yarn abrasion and rapid cord wear, the cover is plaited with double twisted yarns. Specifically, yarns are primary twisted in a first direction at a high turn per metre (TPM) and then two or more primary twisted yarns are secondary twisted together at a high TPM. Plaiting with twisted yarns considerably improves the abrasion performance of the cord, however the additional steps of twisting the yarns in two directions is time consuming, labour intensive, requires additional equipment and consequently is expensive. To reduce manufacturing costs, it is common for cord manufacturers to interweave twisted fibres with untwisted (flat) fibres, for example by incorporating a twisted fibre between every third flat fibre in the plaited weave. The downside with this is that the resulting cord has inferior abrasion properties than a cord plaited entirely with twisted fibres.

It is intended with the present invention to provide a flat cord suitable for use with roller doors which has good abrasive qualities and is cost effective to produce.

### SUMMARY OF THE INVENTION

According to the present invention there is provided a flat low friction cord comprising a flexible and substantially flat core enshrouded by a knitted cover; the cover being knitted around the core from yarns, wherein the knitted yarns at the cord surface define a low friction and abrasion resistant sliding surface.

Preferably, the yarns are oriented substantially along the cord than transversely to it.

Preferably, the yarns are twisted in one direction. Preferably, the knitted cover sufficiently covers the flat core such that the core cannot be seen through the cover. The denier of the yarns is preferably 1500 denier and the yarn fibres are preferably a polyester, nylon, polypropylene or the like, with polyester and nylon the preferable yarn fibres. The core may be a foamed PVC, polyester, polyethylene, polypropylene or the like but is preferably extruded foamed PVC. The cord may be heat set to firmly enshroud the cover around the core.

According to the present invention there is further provided a method of producing a flat low friction cord including:

moving a flexible and substantially flat core through an aperture in a knitting head, wherein needles threaded with yarns are provided on the knitting head around the aperture; and

knitting the yarns around the moving core by moving the knitting head and needles in a knitting pattern and forming a knitted cover enshrouding the core.

Preferably, the method further includes knitting the cover to produce yarns at the surface of the cord oriented substantially along the cord than transversely to the cord.

The method preferably includes firstly primary twisting at least some yarn fibres in a first direction at low turns per metre, typically 80 turns per metre. The yarns are preferably subjected to a high yarn tension before knitting. Preferably, the method includes rotating the head, lifting the head and lifting the needles off the head to knit the yarn fibres into a cover according to the knitting pattern. Preferably, the head is rotated between 45° and 270° and lifted between 15 and 30 mm. The method further includes heat setting the cover to firmly enshroud it around the core.

According to the present invention there is still further provided an apparatus for producing flat low friction cord comprising:

a cylindrical knitting head mounted on a base and having a central longitudinal aperture which is adapted to receive a flexible and substantially flat cord core moving therethrough, the knitting head being movable relative to the base;

needles mounted on the knitting head around the aperture and individually moveable from a retracted position on the knitting head to an extended position;

guiding means adapted to guide yarns from a yarn supply to the needles through which the yarns are threaded;

feeding means to move the core through the aperture; and

driving means for separately moving the knitting head and the needles in a knitting pattern so as to knit the yarns into a cover enshrouding the substantially flat core.

Preferably, the head is capable of rotation and reciprocating movement in a direction parallel to the cord. The needles are also preferably capable of reciprocating movement in a direction parallel to the cord. The head preferably rotates between 45° and 270° and lifts a distance of 20-30 mm.

The apparatus also preferably includes a tensioning means for tensioning the yarns during knitting to firmly enshroud the cover around the core. There are preferably 4 to 24 needles mounted on the knitting head around the aperture. The apparatus is preferably provided with creels defining the yarn supply.

According to the present invention there is still further provided a knitting head for knitting a yarn fibre cover onto a substantially flat core to produce a flat low friction cord, the knitting head being adapted to be moveably mounted on a knitting apparatus and comprising a cylindrical body having a central longitudinal aperture for receiving the core therethrough;

needles spaced around an upper end of the cylindrical body and individually moveable from a retracted position to an extended position, wherein the needles are adapted to be threaded with yarns;

whereby the knitting head is adapted to move in synchronisation with the needles so as to knit the cover around and onto the core.

### BRIEF DESCRIPTION OF THE DRAWINGS

The present invention is described further by way of example with reference to the accompanying drawings of which:

Figure A is an illustration of a prior art cord;

FIG. 1 is an illustration of the flat knitted cord in accordance with the present invention;

FIG. 2 is a side view of an apparatus for producing the flat knitted cord; and

FIG. 3 is a schematic illustration of knitting patterns.

### DETAILED DESCRIPTION OF PREFERRED EMBODIMENT OF INVENTION

The present invention relates to a flat, abrasive resistant cord comprising a flexible and substantially flat core enshrouded with a yarn cover. The yarn cover is knitted onto the core rather than plaited. Plaiting involves interlacing yarn fibres directly off bobbins. Knitting, on the other hand, involves interlocking loops of yarn using needles. Whilst a plaited cord cover configuration produces a stronger cord, in some applications, such as roller door cords, the strength of the cord is of secondary importance to the cord's ability to withstand abrasive forces and have low surface friction. It has been found that a knitted yarn configuration will provide greater resistance to abrasion and lower surface friction than a plaited yarn configuration. This has been attributed to flatter yarn crossover achieved with knitting compared with the more prominent crossover achieved with plaiting. Furthermore, a knit pattern produces a configuration where the knitted yarns run in a direction substantially along the cord length and therefore in the general direction of sliding forces on the cord's surface. The orientation of yarns at the surface of the cord form a substantially longitudinal zig-zag pattern along the length of the cord, and are thus substantially oriented in the direction of travel of the roller door cord. In general, yarns on a flat plaited cord are plaited one under the other and are angled approximately 45° to the longitudinal direction of the cord. The plaited pattern formed on the outside of the cover is similar to the pattern formed on the inside of the cover. In comparison, a knitted pattern produces a product where the yarns on one side of the product are directed more in a longitudinal direction whereas the yarns on the opposite side are directed more in a transverse direction. Accordingly, a knitted cover can be produced with yarns on the outside of the cover directed more in a longitudinal direction of the cord than in a transverse direction. Thus, as a cord travels longitudinally over a contact surface the substantially longitudinal yarns offer less frictional resistance compared with transverse yarns. A cord with a knitted cover with outer yarns directed longitudinally of the cord therefore has a lower frictional coefficient and is able to slide more smoothly, and with minimal vibration, over a surface. The yarn fibres experience greater resistance to abrasion which in turn translates into less wear.

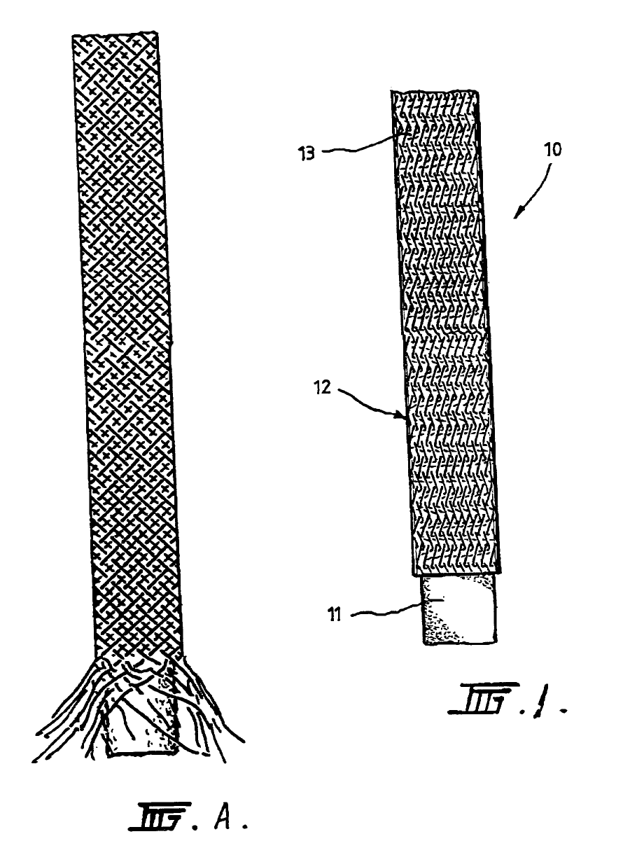

FIG. 1 illustrates a flat knitted cord 10 comprising a substantially flat extruded polyvinylchloride (PVC) core 11 enshrouded with a knitted yarn cover 12. Yarns 13 on the knitted cover 12 are shown extending along the length of the cord in a longitudinal zig-zag pattern where the yarns are angled at approximately 10°-45° to the longitudinal direction of the cord. As a comparison, the yarns of the prior art cord illustrated in Figure A zig-zag across the cord and cross-over each other at an angle of approximately 45° to the longitude of the cord. The crossing-over of yarns by plaiting produces a rougher cord surface profile than the smoother, low friction surface achieved with a knitted cover.

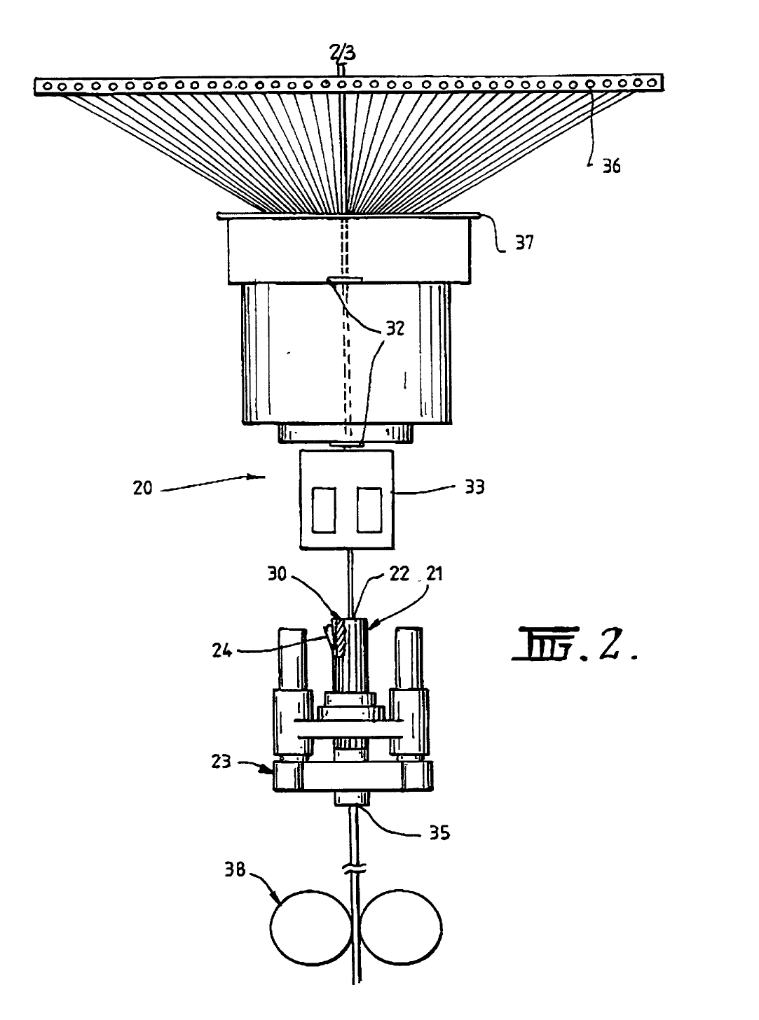

FIG. 2 illustrates the basic components of a knitted cord machine 20 for producing the flat knitted cord 10. Machine 20 comprises a base 23 on which is mounted a cylindrical knitting head 21 having a bore 22 therethrough. Knitting head 21 is vertically moveable on base 23 and capable of rotating clockwise and counter-clockwise. An uncovered core is fed downwardly through bore 22. Mounted on the circumference of knitting head 21 is a number of needles 24 which reciprocate up and down relative to the knitting head from a position below the top 30 of the knitting head to a position above the top 30 of the knitting head. Movement of knitting head 21 and needles 24 is effected by a reciprocating needle drive system. By synchronised movement of the needles 24 and knitting head 21, yarns threaded through each needle are crossed-over and interlooped relative to one another to create a knitted weave.

A creel (not shown) of yarn packages is located directly behind the cord machine 20 and remote from it. Yarn from each package is passed through a tensioning disk (not shown) located on the creel. The number of yarn packages is equal to the number of needles 24 on the knitting head 21. The yarn is then threaded through a yarn guide bar 36 followed by a circular yarn guide 37 located at the top of the cord machine 20. Yarns are illustrated in FIG. 2 threaded through yarn guide bar 36, but for the purposes of clarity are not shown threaded through the remainder of the machine 20. The yarns pass down through an aperture 32 and then through the circular yarn guide 33 which evenly spaces the yarns and prevents them crossing over.

The yarns are circumferentially spaced above the knitting head and at a diameter substantially larger than the diameter of the knitting head such that the yarns angle downwards and inwardly towards the needles and clear of the core moving down through the knitting head. Aperture 32, circular yarn guide 33 and knitting head 21 are all concentrically aligned so as to allow the uncovered core to extend down through aperture 32, through the circular yarn guide 33 and through bore 22 in knitting head 21. A set of haul-off rollers 38 located directly below the knitting head pulls the cord at a set feed rate downwardly through the concentrically aligned knitting head, circular yarn guide and opening.

Meanwhile, the reciprocating needle drive system actuates movement of the knitting head and threaded needles to knit the cover around the core. The covered core exits from a lower opening 35 in the machine passing around and through the haul-off rollers 38 and is wound onto a reel for storage and transportation.

Machine parameters are adjusted to preferred settings for optimum machine performance and for optimum knitted cord characteristics. Knitting a round cover onto a flat core produces a less than ideal fit of the cover on the core. Aside from being prone to fraying, a loosely fitted cover moves about on the core and can cause cord slip during use or generally inferior sliding performance. A sufficiently high yarn tension ensures the knitted cover fits firmly around the flat core without causing the core to warp.

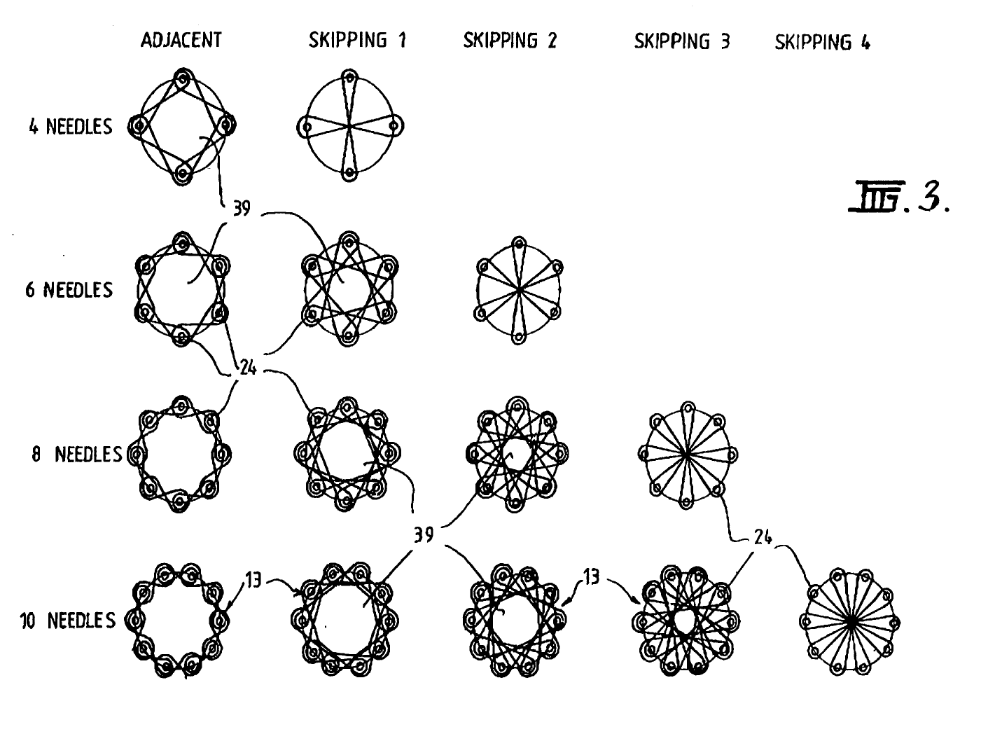

The knitting pattern is determined by various parameters including head twist, head lift, pitch (the distance between the top of the needle and the top of the head), the number of needles, needle lift and weave pattern. Various weave patterns are schematically illustrated in FIG. 3. Needles 24 are schematically illustrated arranged in a circle. As with conventional knitting, needle skipping and the number of needles determines the pattern of weave and consequently the characteristics of the weaved product. FIG. 3 illustrates the different types of knitting patterns achieved with different numbers of needles and different weaves. Specifically, each row of schematic patterns represents heads having different numbers of needles with four needles, six needles, eight needles and ten needles from the top row to the bottom row respectively. Each column respectively from left to right represents patterns achieved by looping adjacent needles, skipping one needle, skipping two needles, skipping three needles and skipping four needles. Understandably, achieving a pattern with a greater number of skipped needles requires a greater number of needles to skip. It can be seen from FIG. 3 that the hole 39 created by the knitted pattern reduces in size with the greater number of needles skipped until the point is reached where hole 39 is eliminated by direct crossing of yarns from one needle to the needle opposite on the knitting head. Given that the present cord is produced by knitting a cover around a rubber core, a hole 39 in the knitting pattern is essential to allow the core to pass through. Of the schematic illustrations illustrated in FIG. 3 the most preferable pattern for achieving a knitted cover around a flat core is the pattern using ten needles and adjacent needle looping. This knitted weave construction creates a flexible cylindrical knitted cover suitable for conforming around the flat core. In the preferred embodiment the cover is knitted using a fourteen needle knitting head.

The preferred knitting pattern is achieved with a head twist of between 90° and 180° and specifically 135°. Ideally, the head twists at 225 cycles per minute. Head lift is preferably at 15-30 mm and specifically 28 mm. The pitch can be between 1-5 mm and preferably 2.7 mm. The schematic illustration in FIG. 3 illustrates needles ranging from as little as 4 although as many as 32 needles can be used. An adequately fitted cover is achieved when the flexible core can no longer be seen through the cover.

The yarns typically have a denier of 100 to 10000 denier. Whilst flat yarns may be used, twisted yarns increase the abrasion performance of the cover. However, owing to the already increased abrasion resistance of the knitted cover the yarns need only be primary twisted thereby reducing time and cost of double twisting.

The typical production rate of the knitted cord is 150 metres per hour. Coating the core with adhesives prior to yarn knitting secures the cover to the core more firmly. Alternatively, heat-setting the product in an oven or over hot rollers assists in shrinking the cover and thereby tightening the cover around the core. With heat-setting, the cord is transferred to an oven or passed over hot rollers after exiting the cord machine. Heat-setting knitted cord has the additional advantage of smoothing the cover surface thereby further reducing the cord's frictional coefficient and susceptibility to abrasion.

The present flat knitted cord, and apparatus and process for the production thereof, provides significant improvements in the quality of abrasion resistant cords, as well as manufacturing efficiency and cost savings over known manufacturing processes. The present process requires fewer stages in that yarn fibres require only single twisting, if at all. Known plaiting processes require constant monitoring to ensure all bobbins in a plaiting machine (typically 64) contain yarn. The present process requires fewer yarns and, because the yarns can be stored on large creels remote of the cord machine, the process is less labour intensive and the cord machine is smaller and simpler. The cord itself is superior in performance over known cords owing to the smooth, well distributed cover, flat yarn crossovers and the generally longitudinal orientation of the yarn fibres achieved with a knitting pattern. The outcome in terms of roller door performance is a smoother and more silent roller door motion. Additionally, reduction in cord wear leads to an extended cord life.

It is understood that whilst it is presently envisaged that the flat knitted cord has particular application with roller door systems, it is intended that the cord may have equal application in other areas of cord use where abrasion performance and surface friction are important considerations in cord design. For example the cord could be incorporated as a flat low friction liner on a conveyor system for smooth, controlled conveying. Accordingly, the dimensions of the cord will vary depending on the application. For example, in roller door systems it is envisaged that the cord width will correspond to the width of the guide rails, where two typical width sizes are 17 mm and 25 mm.

It will be understood to persons skilled in the art of the invention that many modifications may be made without departing from the spirit and scope of the invention.

The claims defining the invention are as follows:

1. A flat low friction cord comprising a flexible and substantially flat core enshrouded by a knitted cover; the cover being knitted around the core from yarns, wherein the knitted yarns at the cord surface define a low friction and abrasion resistant sliding surface.

2. The cord according to claim 1 wherein the yarns at the cord surface are oriented more in a longitudinal direction of the cord than in a transverse direction.

3. The cord according to claim 1 wherein the yarns at the cord surface extend in a continuous zig-zag pattern along a length of the cord.

4. The cord according to claim 1 wherein at least some of the yarns are pre-twisted in one direction.

5. The cord according to claim 1 wherein the yarn has a denier of between 100 and 10,000.

6. The cord according to claim 5 wherein the yarn has a denier of 1500.

7. The cord according to claim 1 wherein the knitted cover is sufficiently dense to substantially cover the flat core.

8. The cord according to claim 1 wherein the yarn fibres are preferably a synthetic fibre.

9. The cord according to claim 8 wherein the yarn is a polyester, polypropylene or nylon fibre.

10. The cord according to claim 1 wherein the cord is a foamed polymer.

11. The cord according to claim 10 wherein the material of the core is polyvinyl chloride, polyester, polyethylene or polypropylene.

12. The cord according to claim 11 wherein the core is extruded foamed polyvinyl chloride.

13. The cord according to claim 1 wherein the core is coated with adhesive underneath the knitted cover.

14. The cord according to claim 1 wherein the cover is heat set onto the core.

15. A method of producing a flat low friction cord including:
moving a flexible and substantially flat core through an aperture in a knitting head, wherein needles threaded with yarns are provided on the knitting head around the aperture; and
knitting the yarns around the moving core by moving the knitting head and needles in a knitting pattern and forming a knitted cover enshrouding the core.

16. The method according to claim 15 including knitting the yarns such that they are oriented more in a longitudinal direction of the cord than a transverse direction.

17. The method according to claim 15 including tensioning the yarn to a high tension before knitting.

18. The method according to claim 15 including pre-twisting at least some of the yarn fibres in a first direction at low turns per metre.

19. The method according to claim 18 whereby the yarns are twisted at 80 turns per metre.

20. The method according to claim 15 wherein the knitting pattern includes skipping 0, 1, 2, 3 or 4 needles.

21. The method according to claim 15 including using a knitting head having 14 needles and knitting a knitting pattern without skipping needles.

22. The method according to claim 15 including knitting the yarns by twisting the head, lifting the knitting head and extending the needles above the knitting head thereby defining the pitch.

23. The method according to claim 22 including twisting the knitting head through between 90° and 180°.

24. The method according to claim 23 including twisting the knitting head through at 135°.

25. The method according to claim 22 including twisting the knitting head at 225 cycles per minute.

26. The method according to claim 22 including lifting the knitting head between 15-30 mm.

27. The method according to claim 26 including lifting the knitting head 28 mm.

28. The method according to claim 22 including setting the pitch between 1-5 mm.

29. The method according to claim 28 including setting the pitch at 2.7 mm.

30. The method according to claim 15 including moving the flat core down through the knitting head at approximately 150 metres per hour.

31. The method according to claim 15 including covering the flat low friction cord in adhesive.

32. The method according to claim 15 including heat setting the flat low friction cord.

33. An apparatus for producing flat low friction cord comprising:
a cylindrical knitting head mounted on a base and having a central longitudinal aperture which is adapted to receive a flexible and substantially flat cord core moving therethrough, the knitting head being movable relative to the base;
needles mounted on the knitting head around the aperture and individually moveable from a retracted position on the knitting head to an extended position;
guiding means adapted to guide yarns from a yarn supply to the needles through which the yarns are threaded;
feeding means to move the core through the aperture; and
driving means for separately moving the knitting head and the needles in a knitting pattern so as to knit the yarns into a cover enshrouding the substantially flat core.

34. The apparatus according to claim 33 wherein the knitting head is twistable around the core and reciprocally movable parallel to the core defining head lift.

35. The apparatus according to claim 33 wherein the knitting head is twistable through between 90° and 180°.

36. The apparatus according to claim 35 wherein the knitting head is twistable through 135°.

37. The apparatus according to claim 34 wherein the head is twistable at 225 cycles per minute.

38. The apparatus according to claim 34 wherein the head lift is 15 mm to 30 mm.

39. The apparatus according to claim 38 wherein the head lift is 28 mm.

40. The apparatus according to claim 33 wherein the needles lift above the knitting head at a pitch of 1-5 mm.

41. The apparatus according to claim 40 wherein the pitch is 2.7 mm.

42. The apparatus according to claim 33 wherein the number of needles provided around the aperture is a multiple of 2 between 4 to 32 needles.

43. The apparatus according to claim 42 wherein the number of needles is 14.

44. The apparatus according to claim 33 wherein tensioning means is provided to tension the yarns during knitting.

45. The apparatus according to claim 33 wherein the guiding means is a circular yarn guide provided above the knitting head and having a diameter larger than the knitting head to guide yarns from a yarn source through the yarn guide downwardly and inwardly toward the needles on the knitting head.

46. The apparatus according to claim 33 wherein the feeding means comprises haul-off rollers located below the knitting head to move the core downwardly through the aperture.

47. A knitting head for knitting a yarn fibre cover onto a substantially flat core to produce a flat low friction cord, the knitting head being adapted to be moveably mounted on a knitting apparatus and comprising a cylindrical body having a central longitudinal aperture for receiving the core therethrough;
needles spaced around an upper end of the cylindrical body and individually moveable from a retracted position to an extended position, wherein the needles are adapted to be threaded with yarns;
whereby the knitting head is adapted to move in synchronisation with the needles so as to knit the cover around and onto the core.
